(19) United States
(12) Patent Application Publication
(10) Pub. No.: US 2009/0226776 A1
(43) Pub. Date: Sep. 10, 2009

(54) HYDROGEN CHARGING APPARATUS

(75) Inventors: Jin-Ho Kim, Seoul (KR); Kyoung-hwan Choi, Suwon-si (KR); Jae-yong Lee, Yongin-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/144,957

(22) Filed: Jun. 24, 2008

(30) Foreign Application Priority Data
Mar. 4, 2008 (KR) 2008-20084

(51) Int. Cl. H01M 8/04; H01M 8/18

(52) U.S. Cl. 429/17; 429/20

(57) ABSTRACT

A hydrogen charging apparatus having a cooling unit in which the hydrogen charging apparatus includes a hydrogen generation unit that generates hydrogen, a hydrogen charging unit that charges hydrogen to a hydrogen storage medium, and a cooling unit that reduces the pressure of hydrogen to a suitable level for charging by cooling the hydrogen storage medium during charging the hydrogen.

### CROSS-REFERENCE TO RELATED APPLICATIONS

This application claims the benefit of Korean Patent Application No. 10-2008-0020084, filed on Mar. 4, 2008, in the Korean Intellectual Property Office, the disclosure of which is incorporated herein by reference.

### BACKGROUND OF THE INVENTION

1. Field of the Invention

Aspects of the present invention relate to a hydrogen charging apparatus that generates hydrogen for fuel in an electricity generation reaction in a fuel cell and stores the hydrogen in a storage medium.

2. Description of the Related Art

A fuel cell is an electrochemical conversion device that changes the chemical energy of a fuel into electrical energy through a chemical reaction. When air including oxygen is supplied to a cathode and hydrogen as fuel is supplied to an anode of the fuel cell, electricity is generated by a reverse reaction of water electrolysis through an electrolyte membrane. In order to maintain such an electricity generation reaction, hydrogen as fuel is generally maintained in an appropriate storage medium in the fuel cell.

Recently, in line with the developments to use fuel cells in mobile devices, a solid hydrogen storage medium that has a relatively small volume and can be readily operated has drawn attention for use as a storage medium in which hydrogen is charged, instead of using a large storage container, such as a pressure container. The solid hydrogen storage medium is formed of an alloy that can store hydrogen. At an appropriate pressure and temperature condition for charging hydrogen, the solid hydrogen storage medium stores hydrogen by adsorption, for example, and discharges the hydrogen when an appropriate pressure and temperature condition for discharging the hydrogen is achieved.

Thus, if the appropriate pressure and temperature conditions are satisfied, the storage and discharge of hydrogen, i.e., charging and discharging hydrogen, can be readily performed.

### SUMMARY OF THE INVENTION

Aspects of the present invention provide a hydrogen charging apparatus having a hydrogen storage medium that can readily store and discharge hydrogen.

According to an aspect of the present invention, there is provided a hydrogen charging apparatus comprising a hydrogen generation unit that generates hydrogen, a hydrogen charging unit that charges hydrogen to a hydrogen storage medium, and a cooling unit that cools the hydrogen storage medium.

According to an aspect of the present invention, the hydrogen storage medium may be a solid hydrogen storage medium formed of one selected from a metal hydride, a complex metal hydride, a carbon group material, and a non-carbon material.

According to an aspect of the present invention, the cooling unit may be installed in the hydrogen charging unit and may perform a cooling function using one selected from a thermo-refrigerator, a thermo-acoustic refrigerator, and a phase change of a coolant.

According to an aspect of the present invention, the hydrogen generation un generate hydrogen using one selected from an electrolysis reaction and a catalyst reaction.

According to an aspect of the present invention, the hydrogen generation unit that uses an electrolysis reaction may be one selected from an electrolyzing unit that uses an alkali aqueous solution as an electrolyte, an electrolyzing unit that uses an ion conductive membrane as an electrolyte, and an electrolyzing unit that uses an oxidation and reduction reaction of an optical catalyst by radiating light to the optical catalyst.

According to an aspect of the present invention, the hydrogen generation unit that uses the oxidation and reduction reaction of an optical catalyst may generate hydrogen by reacting one optical catalyst selected from an alkali metal and a borohydride (MₓBH_{y}) with water.

According to an aspect of the present invention, the pressure of hydrogen that is supplied to the hydrogen charging unit from the hydrogen generation unit may be in a range from 0.01 to 10 atm. The cooling unit may have a cooling temperature range of −20 to +30° C.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a schematic drawing of a structure of a hydrogen charging apparatus according to an embodiment of the present invention; and

FIG. 2 is a graph showing a hydrogen charging and discharging characteristic of a solid hydrogen storage medium according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

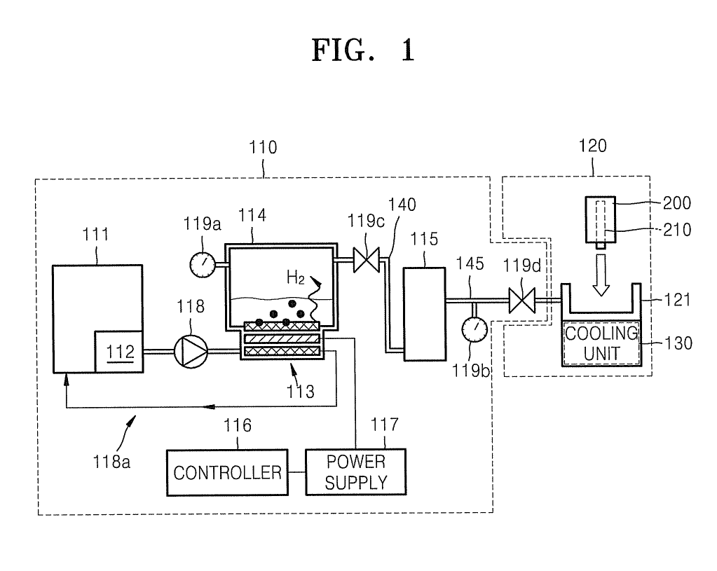

FIG. 1 illustrates a schematic drawing of a structure of a hydrogen charging apparatus according to an exemplary embodiment of the present invention. Referring to FIG. 1, the hydrogen charging apparatus includes a hydrogen generation unit 110, a hydrogen charging unit 120 that charges hydrogen in a solid hydrogen storage medium 210 built in a hydrogen storage cartridge 200, and a cooling unit 130 that cools the solid hydrogen storage medium 210 during hydrogen charging.

The hydrogen generation unit 110 generates hydrogen by electrolyzing water, and includes a water tank 111 in which water is stored, an electrolyzing unit 113 that generates hydrogen by electrolyzing water supplied from the water tank 111 by a pump 118, a gas-liquid separation tank 114 that separates water from hydrogen using specific gravity, and a dehumidifier 115 that removes moisture mixed with the hydrogen.

When water is supplied to the electrolyzing unit 113 from the water tank 111 and power is supplied to the electrolyzing unit 113 from a power supply unit 117 under the control of a controller 116, hydrogen is generated in the electrolyzing unit 113 through water electrolysis. The water tank 111 includes a purifying unit 112 that removes impurities prior to supplying the water stored in the water tank 111 to the electrolyzing unit 113. However, aspects of the present invention are not limited thereto such that the purifying unit 112 need not be disposed in the water tank 111 and may be disposed in the hydrogen generation unit 110 to purify the water before the water reaches the electrolyzing unit 113. The generated hydrogen is separated from the water in the gas-liquid separation tank 114 and supplied to the dehumidifier 115 via the supply line 140. A valve 119c is disposed in the supply line 140 to control the flow between the gas-liquid separation tank 114 and the dehumidifier 115. The generated hydrogen is then supplied to the hydrogen charging unit 120 via a supply line 145 in which a valve 119d is disposed to control the flow of the generated hydrogen. The remaining water in the electrolyzing unit 113 is returned to the water tank 111 through the water return line 118a. Also, the oxygen generated in the electrolyzing unit 113 is returned to the water tank 111 like the remaining water, and then exhausted to the outside through the water tank 111. Further, pressure sensors 119a and 119b measure the pressures in the gas-liquid separation tank 114 and the supply line 119b. However, aspects of the present invention are not limited thereto such that pressure sensors may be disposed in other places within the hydrogen generation unit 110 and the hydrogen charging unit 120.

The electrolyzing unit 113 may be an alkali aqueous solution electrolyzing unit that uses an alkali aqueous solution having a concentration of 25 to 30 wt % as an electrolyte, a proton exchange membrane (PEM) electrolyzing unit that electrolyzes water using an ion-conducting membrane instead of a liquid electrolyte, or an optical catalyst electrolyzing unit that electrolyzes water through a strong oxidation and reduction reaction generated by radiating light to an optical catalyst. Although the electrolyzing unit 113 is described in the present exemplary embodiment, aspects of the present invention are not limited thereto such that a method of producing hydrogen from water using a catalyst reaction may be employed. That is, an apparatus that directly generates hydrogen by reacting a catalyst, for example, an alkali metal such as Al, Mg, or Na or a borohydride (MₓBH_{y}; M=Na, Li, K), with water may be employed instead of the electrolyzing unit 113. Although the electrolyzing unit 113 is illustrated as being disposed in or as part of the gas-liquid separation tank 114, aspects of the present invention are not limited thereto such that the electrolyzing unit 113 may be disposed independent of the gas-liquid separation tank 114. Also, the power supply 117 is not needed in all aspects. Further, aspects allow for any method of providing hydrogen to the hydrogen charging unit 120 to be charged in the solid hydrogen storage medium 210.

The hydrogen charging unit 120 stores hydrogen generated from the hydrogen generation unit 110, and more specifically, hydrogen is charged in the solid hydrogen storage medium 210 which is built in the hydrogen storage cartridge 200. Although described herein as built in, the solid hydrogen storage medium 210 may be attachable to and/or detachable from the hydrogen storage cartridge 200 and the solid hydrogen storage medium 210 need not be constructed together or simultaneously with the hydrogen storage cartridge 200. The hydrogen storage cartridge 200 is mountable in a charging cradle 121. If the hydrogen storage cartridge 200 is mounted on the charging cradle 121, the hydrogen generation unit 110 and the hydrogen storage cartridge 200 are connected to each other through the charging cradle 121 so that hydrogen generated in the hydrogen generation unit 110 can be injected into the solid hydrogen storage medium 210. The connection structure between the hydrogen generation unit 110 and the hydrogen storage cartridge 200 through an intermediate adaptor such as the charging cradle 121 is well known in the art, and thus, the detailed description thereof will be omitted.

The cooling unit 130 is built in the charging cradle 121 of the hydrogen charging unit 120 to cool the charging cradle 121 during hydrogen charging, and thus, cools the solid hydrogen storage medium 210 of the hydrogen storage cartridge 200 mounted to the charging cradle 121. Although described as built in, the cooling unit 130 may be attachable to or detachable from the charging cradle 121 and need not be constructed together or simultaneously with the charging cradle 121. The cooling unit 130 may be a thermoelectric refrigerator, a thermo-acoustic refrigerator, or a cooler that uses a phase change of a coolant, and may be configured to cool the charging cradle 121 to a temperature of about −20° C. to +30° C. since the hydrogen storage characteristic varies according to temperature and type of the solid hydrogen storage medium 210.

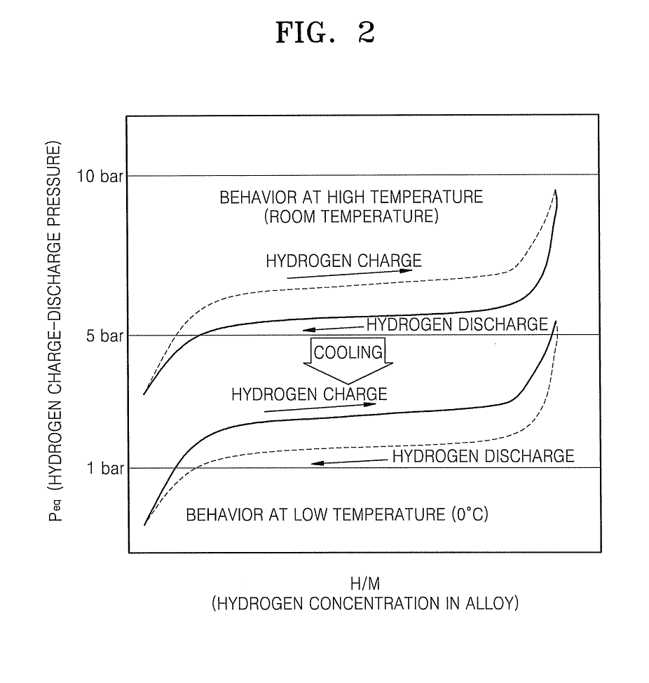

The temperature of the solid hydrogen storage medium 210 is decreased during hydrogen charging using the cooling unit 130 due to at least reasons described below. FIG. 2 is a graph showing hydrogen charging and discharging characteristics of the solid hydrogen storage medium 210 according to an exemplary embodiment of the present invention. The graph in FIG. 2 shows the hydrogen charging and discharging characteristics when the solid hydrogen storage medium 210 is formed of a hydrogen charging alloy of an AB₅ type, such as MmNi₅ [Mm (a mischmetal) is an alloy of La and Ce]. Referring to FIG. 2, hydrogen is stored in the solid hydrogen storage medium 210 at the same temperature as when hydrogen is discharged from the solid hydrogen storage medium 210, i.e., the graph of FIG. 2 illustrates the hydrogen charging and discharging characteristics at a high temperature and a low temperature. At this point, the hydrogen is stored in the solid hydrogen storage medium 210 (i.e., charged) at a relatively high pressure and is discharged at a relatively low pressure compared to the pressure when hydrogen is stored.

However, ideally, a reverse trend of the above case is preferable. That is, hydrogen must be readily charged in the solid hydrogen storage medium 210 even though the hydrogen pressure is low during charging, and the hydrogen pressure must be high during discharging hydrogen so that hydrogen is smoothly supplied to an anode of a fuel cell. If the charging is not satisfactory due to the low pressure of hydrogen supplied from the hydrogen generation unit 110, a booster, such as a compressor for increasing pressure, may be installed in the hydrogen generation unit 110, and if the pressure of hydrogen is low during discharging, an additional heating apparatus may be installed around the solid hydrogen storage medium 210 in order to induce a smooth discharge of hydrogen.

As depicted in FIG. 2, since the practical situation shows trends in which charging pressure is high and discharging pressure is low, a proper operation can hardly be expected. However, although in the case of the same solid hydrogen storage medium 210, if the temperature is reduced, as shown in FIG. 2, both the charging pressure and the discharging pressure of hydrogen are reduced. That is, the hydrogen pressure for charging is reduced using the above characteristics. In other words, if the temperature for hydrogen charging is reduced when hydrogen is charged in the solid hydrogen storage medium 210, as shown in the graph, the pressure of the hydrogen charging characteristics is reduced. This denotes that the hydrogen charging is achieved satisfactorily in the solid hydrogen storage medium 210 compared to a case when a temperature is high although the pressure of hydrogen supplied from the hydrogen generation unit 110 is low. Accordingly, the hydrogen charging may be satisfactorily achieved without the need for an installation of an additional booster. Also, when the solid hydrogen storage medium 210, in which hydrogen is charged, is used for an operation of an electronic apparatus, since the temperature is raised to room temperature, the characteristics of the solid hydrogen storage medium 210 return to the original characteristic. Accordingly, the pressure of hydrogen when hydrogen is discharged is raised higher than a cooled state, and thus, hydrogen supply to the anode is achieved smoothly. That is, the ideal hydrogen charging and discharging characteristic (corresponding to solid lines in FIG. 2), are achieved such that the characteristics that hydrogen is charged at a low pressure and is discharged at a high pressure is realized through a cooling process.

Also, in order to rapidly charge hydrogen within 10 minutes, the charging pressure of hydrogen may be increased twice or more than a normal charging pressure. In this way, hydrogen is rapidly cooled, the charging pressure of hydrogen is reduced to half of the normal charging pressure or less, and thus, the hydrogen charging and discharging characteristic according to aspects of the present invention is advantageous for realizing a rapid charging function.

Further, a reaction in which hydrogen reacts with the solid hydrogen storage medium 210 during charging is an exothermic reaction. Thus, if the solid hydrogen storage medium 210 is cooled, charging efficiency is also increased.

The hydrogen charging apparatus may be used in the following manner. The hydrogen storage cartridge 200 to be charged, including the solid hydrogen storage medium, is mounted in the charging cradle 121 of the hydrogen charging unit 120. Thus, the solid hydrogen storage medium 210 built in the hydrogen storage cartridge 200 and the hydrogen supply line 145 are connected through the charging cradle 121.

When hydrogen charging starts in this state, the cooling unit 130 is operated to cool the solid hydrogen storage medium 210, and thus, a hydrogen charging pressure is reduced. Hydrogen is produced from the electrolyzing unit 113 when the hydrogen generation unit 110 is operated, and the hydrogen is charged in the solid hydrogen storage medium 210 of the hydrogen storage cartridge 200 mounted in the charging cradle 121 after the hydrogen passes through the dehumidifier 115. At this point, the pressure sensor 119b installed on an outlet of the dehumidifier 115 detects the pressure of the hydrogen and sends the result to the controller 116 to determine whether the pressure of hydrogen is suitable for charging. When the pressure of hydrogen reaches a suitable level, i.e., above a predetermined pressure, the controller 116 opens the valve 119d to charge hydrogen in the solid hydrogen storage medium 210. Although a suitable pressure for charging hydrogen varies according to the type of the solid hydrogen storage medium 210, a conventional pressure range is 0.01 to 10 atm, and thus, the pressure sensor 119d may have a measuring range of 0.01 to 10 atm. Pressure values suitable for charging hydrogen according to the type of the solid hydrogen storage medium 210 may be set in the controller 116 in advance.

Afterwards, when the hydrogen storage cartridge 200 in which the charging of the hydrogen is completed is removed from the charging cradle 121, the hydrogen storage cartridge 200 exhibits hydrogen charging and discharging characteristics at room temperature as the temperature increases. When the hydrogen storage cartridge 200 is used at room temperature, hydrogen is discharged at a relatively high pressure, and thus, hydrogen is smoothly supplied to an anode. Thus, both charging and discharging hydrogen are easily and smoothly performed.

The solid hydrogen storage medium 210 may be formed of a metal hydride; a complex metal hydride, such as MmNi₅ described above, a carbon group material, such as porous carbon, carbon nanotube, or carbon nanofiber; or a non-carbon material, such as zeolite metal organic framework, mesoporous organosilica, or metal nanotube.

Although a few embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A hydrogen charging apparatus, comprising:
a hydrogen generation unit to generate hydrogen;
a hydrogen charging unit to charge the generated hydrogen to a hydrogen storage medium; and
a cooling unit that cools the hydrogen storage medium.

2. The hydrogen charging apparatus of claim 1, wherein the hydrogen storage medium is a solid hydrogen storage medium.

3. The hydrogen charging apparatus of claim 2, wherein the solid hydrogen storage medium is formed of one selected from a metal hydride, a complex metal hydride, a carbon group material, and a non-carbon material.

4. The hydrogen charging apparatus of claim 1, wherein the cooling unit is installed in the hydrogen charging unit.

5. The hydrogen charging apparatus of claim 4, wherein the cooling unit cools the hydrogen storage medium using one selected from a thermoelectric refrigerator, a thermo-acoustic refrigerator, and a phase change of a coolant.

6. The hydrogen charging apparatus of claim 1, wherein the hydrogen generation unit generates hydrogen using one selected from an electrolysis reaction and a catalyst reaction.

7. The hydrogen charging apparatus of claim 6, wherein the hydrogen generation unit that uses an electrolysis reaction is one selected from an electrolyzing unit that uses an alkali aqueous solution as an electrolyte, an electrolyzing unit that uses an ion conductive membrane as an electrolyte, and an electrolyzing unit that uses an oxidation and reduction reaction of an optical catalyst by radiating light to the optical catalyst.

8. The hydrogen charging apparatus of claim 7, wherein the hydrogen generation unit that uses the oxidation and reduction reaction of an optical catalyst generates hydrogen by reacting one optical catalyst selected from an alkali metal and a borohydride (MₓBH_{y}) with water.

9. The hydrogen charging apparatus of claim 1, wherein the pressure of hydrogen that is supplied to the hydrogen charging unit from the hydrogen generation unit is in a range from 0.01 to 10 atm.

10. The hydrogen charging apparatus of claim 1, wherein the cooling unit cools the hydrogen storage medium to a temperature of −20 to +30° C.

11. A hydrogen charging unit, comprising:
a hydrogen storage cartridge;
a hydrogen storage medium disposed in the hydrogen storage cartridge;
a charging cradle to which the hydrogen storage cartridge is attachable to charge the hydrogen storage medium with hydrogen, the charging cradle being attachable to a hydrogen source which provides the hydrogen to be charged in the hydrogen storage medium; and
a cooling unit to cool the hydrogen storage medium when the hydrogen storage medium is charged with the hydrogen.

12. The hydrogen charging unit of claim 11, wherein the hydrogen storage cartridge is attachable to an external apparatus to discharge the hydrogen charged in the hydrogen storage medium thereto.

13. The hydrogen charging unit of claim 12, wherein the hydrogen charging unit charges the hydrogen storage medium with the hydrogen at a first pressure, and the hydrogen storage medium discharges the hydrogen at a second pressure, the first pressure being less than the second pressure.

14. A hydrogen charging apparatus, comprising:
a hydrogen generation unit comprising:
a water tank to store water,
a gas-liquid separation tank having hydrogen-producing unit disposed therein to generate hydrogen from the water supplied from the water tank, and
a dehumidifier to remove water from the generated water;
a hydrogen charging unit comprising:
a hydrogen storage cartridge,
a hydrogen storage medium disposed in the hydrogen storage cartridge,
a charging cradle attachable to the hydrogen generation unit and to which the hydrogen storage cartridge is attachable to charge the hydrogen storage medium with the hydrogen generated in the hydrogen generation unit, and
a cooling unit to cool the hydrogen storage medium when the hydrogen storage medium is charged with the hydrogen.

15. The hydrogen generating apparatus of claim 14, further comprising a purifying unit to remove impurities from the water before the water is supplied to the electrolyzing unit.

16. The hydrogen generating apparatus of claim 14, further comprising a controller to control the hydrogen generation unit to supply the generated hydrogen to the charging cradle.

17. The hydrogen generating apparatus of claim 14, wherein the hydrogen-producing unit is an electrolyzing unit.

18. The hydrogen generating apparatus of claim 14, wherein the hydrogen-producing unit generates hydrogen from the water using a catalyst reaction.

19. A hydrogen charging method, comprising:
cooling a hydrogen storage medium;
charging hydrogen to the hydrogen storage medium while the hydrogen storage medium is cool.

20. The method of claim 19, wherein the hydrogen storage medium is a solid hydrogen storage medium.

21. The method of claim 19, further comprising:
generating hydrogen in hydrogen-producing unit; and
supplying the generated hydrogen to the hydrogen storage medium to be charged therein.

22. The method of claim 21, further comprising:
dehumidifying the generated hydrogen before the supplying of the generated hydrogen to the hydrogen storage medium.

23. The method of claim 19, further comprising:
determining a pressure of the hydrogen to be charged in the hydrogen storage medium; and
performing the charging of the hydrogen to hydrogen storage medium if the determined pressure is above a predetermined pressure.
